(19) United States
(12) Patent Application Publication
(10) Pub. No.: US 2015/0151509 A1
(43) Pub. Date: Jun. 4, 2015

(54) TAPERED FIBER REINFORCED CORE PANEL

(71) Applicant: MILLIKEN & COMPANY, Spartanburg, SC (US)

(72) Inventors: Michael Tompkins, Cherryville, NC (US); Anthony S. Brandon, Moore, SC (US); Frederick Stoll, Spartanburg, SC (US)

(73) Assignee: MILLIKEN & COMPANY, Spartanburg, SC (US)

(21) Appl. No.: 14/093,751

(22) Filed: Dec. 2, 2013

(51) Int. Cl. B32B 5/14

(52) U.S. Cl. CPC B32B 5/145

(57) ABSTRACT

A tapered fiber reinforced core panel adapted for use with a hardenable resin having a core panel thickness that varies across at least one of the width or length of the core panel. The core panel contains a plurality of elongated strips of low density cellular material and a plurality of fibers located adjacent the first and second side surfaces between adjacent elongated strips.

### FIELD OF THE INVENTION

The present invention generally relates to fiber reinforced core panels.

### BACKGROUND

Composite sandwich panels are widely used in applications which require engineered structural properties and light weight. A prominent example, among many, is the blades of wind turbines used to produce electrical energy. These blades commonly comprise skins of fibrous reinforcements, for example fiberglass fabric, saturated with hardened resin, for example epoxy or polyester. The skins are bonded to cellular core materials, for example balsa wood, plastics foam or composite core materials. In addition to fiber reinforced resins, sandwich panel skins may comprise a wide variety of other stiff materials, for example aluminum, steel or plywood.

There is a need for composite structures to have transitions in thickness (either between two different core thicknesses or a core thickness and an edge) that are smooth and gradual and use materials with similar mechanical properties as the main core material.

### BRIEF SUMMARY

A tapered fiber reinforced core panel adapted for use with a hardenable resin having a core panel thickness that varies across at least one of the width or length of the core panel. The core panel contains a plurality of elongated strips of low density cellular material and a plurality of fibers located adjacent the first and second side surfaces between adjacent elongated strips. A composite formed from the tapered fiber reinforced core panel is also disclosed.

### BRIEF DESCRIPTION OF THE DRAWINGS

FIG. 1 is an illustrative prospective view of one embodiment of a tapered fiber reinforced core panel.

FIG. 2 is an illustrative cross-sectional view of one embodiment of an elongated element within the tapered region.

FIGS. 3-10 are illustrative prospective views of different embodiments of tapered fiber reinforced core panels.

FIG. 11 is an illustrative prospective view of one embodiment of a tapered fiber reinforced core panel.

FIGS. 12 and 13 are illustrative prospective views of embodiments of an elongated element containing reinforcements.

### DETAILED DESCRIPTION

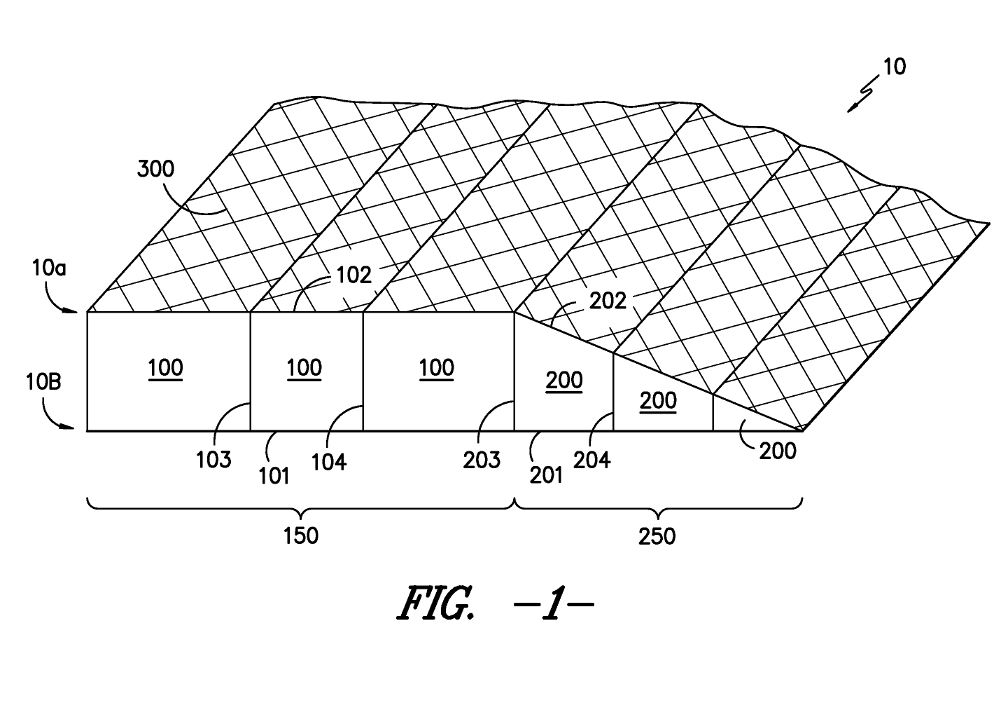

In FIG. 1, there is shown one embodiment of a tapered fiber reinforced core panel 10 containing a plurality of elongated elements 100, 200. The tapered fiber reinforced core panel 10 has an upper core surface 10a and a lower core surface 10b. The core panel 10 has a length (parallel to the elongated elements 100, 200), a width (perpendicular to the elongated elements 100, 200), and a thickness defined as the distance between the upper core surface 10a and the lower core surface 10b. In the tapered fiber reinforced core panel 10, the thickness in the core panel 10 varies in at least one of the width and the length of the core panel 10. In one embodiment, shown in FIG. 1, the thickness of the core panel 10 varies in the width direction of the core panel 10. In another embodiment, the thickness of the core panel 10 varies in the length direction of the core panel 10. In another embodiment, the thickness of the core panel 10 varies both the length direction and width direction of the core panel 10.

In one embodiment, the thickness of the core panel varies by more than about 2%, more preferably more than about 5%, more preferably more than about 10% across the length and/or width of the core panel. In another embodiment, the thickness of the core panel varies by more than about 30%, more preferably more than about 50%, more preferably more than about 90% across the length and/or width of the core panel.

The tapered fiber reinforced core panel 10 contains at least two regions, a flat region 150 and a tapered region 250, each of the regions 150, 250 containing at least one (in one embodiment two or more) of elongated strips 100, 200. A plurality of fibers 300 are located adjacent at least some of the side surfaces 103, 104, 201, 204 between adjacent elongated strips.

The elongated strips 100, 200 each have a length, a longitudinal axis, a first strip surface 102, 202 facing the upper core surface of core panel, a second strip surface 101, 201 facing the lower core surface of core panel, a first side surface 103, 203 connecting the first surface 102, 202 and the second surface 101, 201, and a second side surface 104, 204 connecting the first surface 102, 202 and the second surface 101, 201. The side surfaces 103, 104, 203, 204 of the elongated strips 100, 200 face the side surfaces 103, 104, 203, 204 of adjacent elongated strips 100, 200. In one embodiment, the elongated strips 100, 200 are arranged such that their longitudinal axes are generally aligned. In another embodiment, the elongated strips 100 are arranged such that their longitudinal axes are generally aligned and the elongated strips 200 are arranged such that their longitudinal axes are generally aligned, but the longitudinal axes of the elongated strips 100 and 200 may or may not be aligned with each other.

In the flat region 150 of the tapered reinforced core panel 10, the thickness of the core panel 10 is approximately constant in the width and length of the flat region 150. Preferably, the first strip surface 102 and second strip surface 101 of the elongated strips 100 within the flat region 150 are parallel. In one embodiment where the elongated strips have a rectangular cross-section, all of the angles in the rectangular cross-section (first strip surface 102 to first side surface 103, first strip surface 102 to second side surface 104, second strip surface 101 to first side surface 103, and second strip surface 101 to second side surface 104) would be approximately right angles (approximately 90 degrees).

In the tapered region 250 of the tapered reinforced core panel 10, the thickness in the tapered region 250 varies in at least one of the width and length of the core panel 10. Preferably, in the tapered region 250 of the core panel 10, the first strip surface 202 and second strip surface 201 of the elongated strips 200 are not parallel.

In one embodiment, shown in FIG. 1, the thickness of the tapered region 250 varies in the width direction of the core panel 10. In FIG. 1, it is shown that the second strip surfaces 201 in the tapered region 250 generally lie in the same plane as the second strip surfaces 101 in the flat region 150 such that the second core surface 10b is generally planar. Having one core surface of the tapered fiber reinforced core panel 10 be planar is preferred for some end uses as this enables easier attachment of the core panel 10 to other surfaces or structures (or even other tapered fiber reinforced core panels 10). In this embodiment, the change in thickness within the tapered region 250 is controlled by the first strip surface 202.

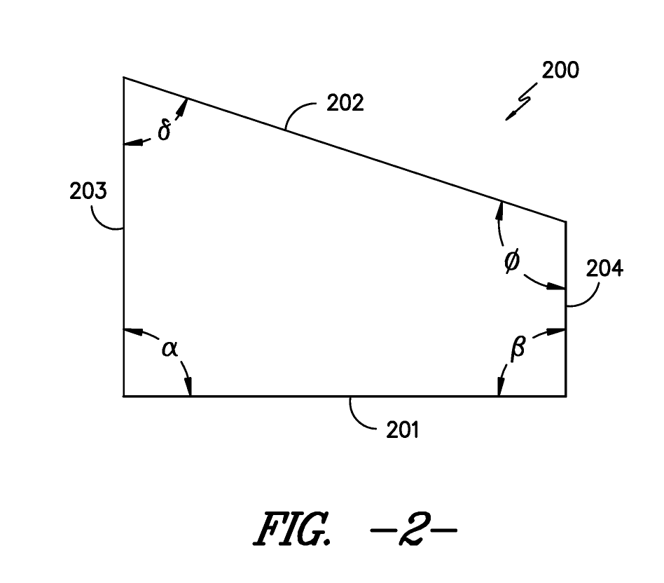

An enlargement of one embodiment of a typical elongated strip 200 from the tapered region 250 of the tapered fiber reinforced core panel 10 of FIG. 1 is shown in FIG. 2. In this embodiment, the first side surface 203 is approximately perpendicular to the second strip surface 201, therefore the angle α is approximately 90 degrees. The second side surface 204 is approximately perpendicular to the second strip surface 201, therefore the angle β is approximately 90 degrees. The angle γ formed between the first strip surface 202 and the first side surface 203 and the angle φ formed between the first strip surface 202 and the second side surface 204 together equal approximately 180 degrees. In the embodiment shown in FIG. 2 where the first strip surface 202 is angled downward from the first side surface 203 to the second side surface 204, the angle φ is greater than 90 degrees and the angle γ is less than 90 degrees. In another embodiment (not shown in the Figures) where the first strip surface 202 is angled upwards from the first side surface 203 to the second side surface 204, the angle φ would be less than 90 degrees and the angle γ would be greater than 90 degrees.

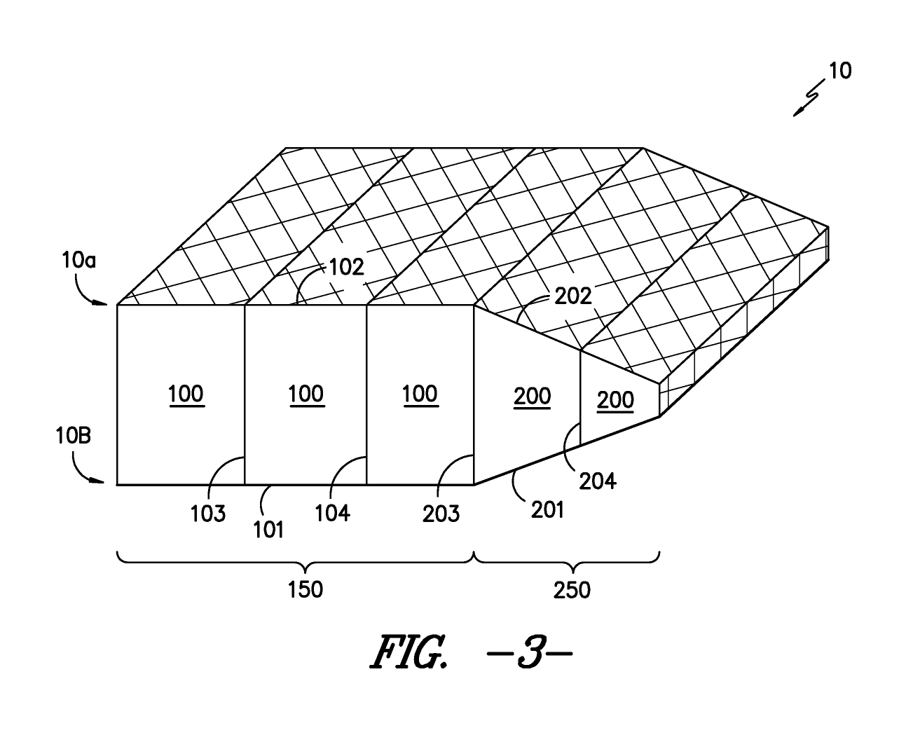

In another embodiment shown in FIG. 3, the first strip surfaces 202 of the tapered region 250 are not planar with the first strip surfaces 102 of the flat region 150 and the second strip surfaces 201 of the tapered region 250 are not planar with the second strip surfaces 101 of the flat region 150. In this embodiment, the tapering of the tapered region 250 is controlled by both the first strip surfaces 202 and the second strip surfaces 201.

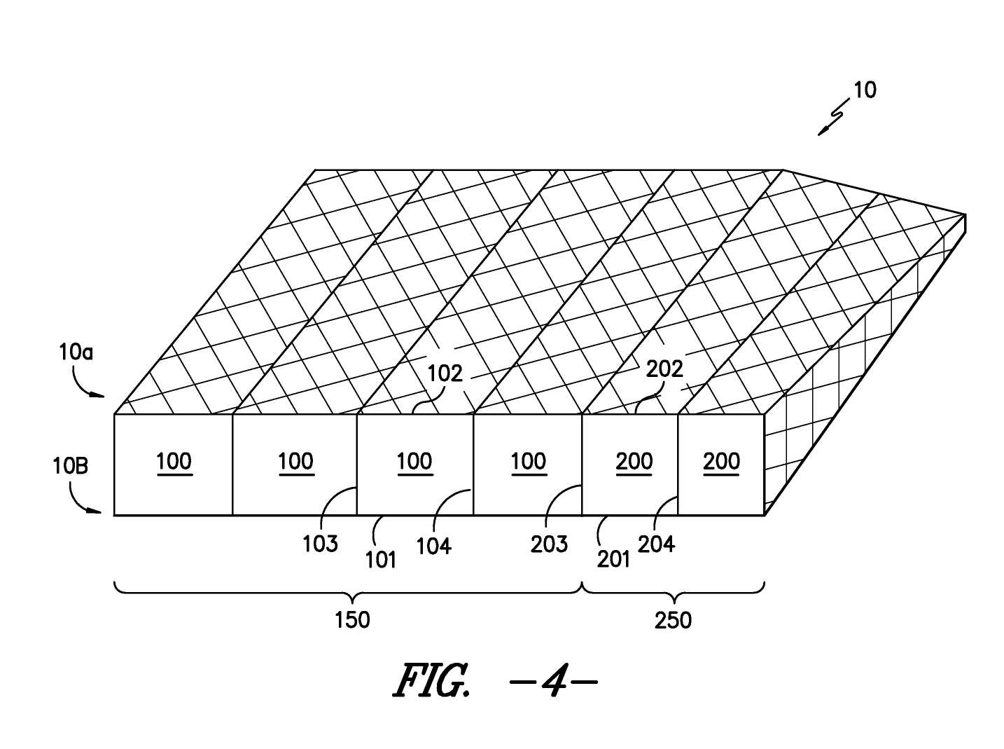

FIG. 4 illustrates another embodiment where the thickness of the tapered region 250 varies in the length direction of the tapered region 250 of the core panel 10. In FIG. 4, in one cross-section of the core panel 10 (shown as the cross section in FIG. 4) the first strip surfaces 102, 202 of the flat region 150 and the tapered region 250 are planar and the second strip surfaces 101, 201 of the flat region 150 and the tapered region 250 are planar. In the tapered region 250, the thickness decreases along the length of the elongated strips 200 such that a distance from the cross-section shown in FIG. 4, the first strip surfaces 102, 202 in the flat region 150 and the tapered region 250 are not planar. In another embodiment, the thickness of the tapered region 250 varies both the length direction and width direction of the core panel 10.

In one embodiment, the first strip surfaces 201 of the tapered region form an angle of between about 5 and 20 degrees measured between the first strip surfaces 201 and the first strip surfaces 101 (also known as the angle φ-90 as shown in FIG. 2). This means that for embodiments where the tapered region begins at the thickness of the flat region 100 and tapers down to an edge, the thicker the flat region, the wider the tapered region 200 will typically be so that the slope (angle of tapered region) is maintained.

Preferably, in the area where the flat region and the tapered region meet (the edge of the flat region and the edge of the tapered region), the flat region 150 and the tapered region 250 have the same thickness. This is preferred as it makes the transition of thickness gradual without a step change. Preferably, the change in thickness in the length or width direction of the tapered region is in a gradient (either increasing or decreasing) from the edge of the tapered region 250 adjacent a flat region 150 to the opposite edge. In one embodiment, the tapered region's surface (formed from the first strip surfaces 202 and/or the second strip surfaces 201) may be flat, concave or convex. In one embodiment, the tapered region 250 contains a hyperbolic curvature where the edges are at a maximum thickness and somewhere in the middle of the tapered region is a minimum thickness (or conversely the edges are at a minimum thickness and there is a maximum thickness somewhere in the middle of the tapered region 250.

In another embodiment, in the area where the flat region and the tapered region meet (the edge of the flat region and the edge of the tapered region), the flat region 150 and the tapered region 250 have a different thickness. The may be preferred for some end uses where a step change is desired.

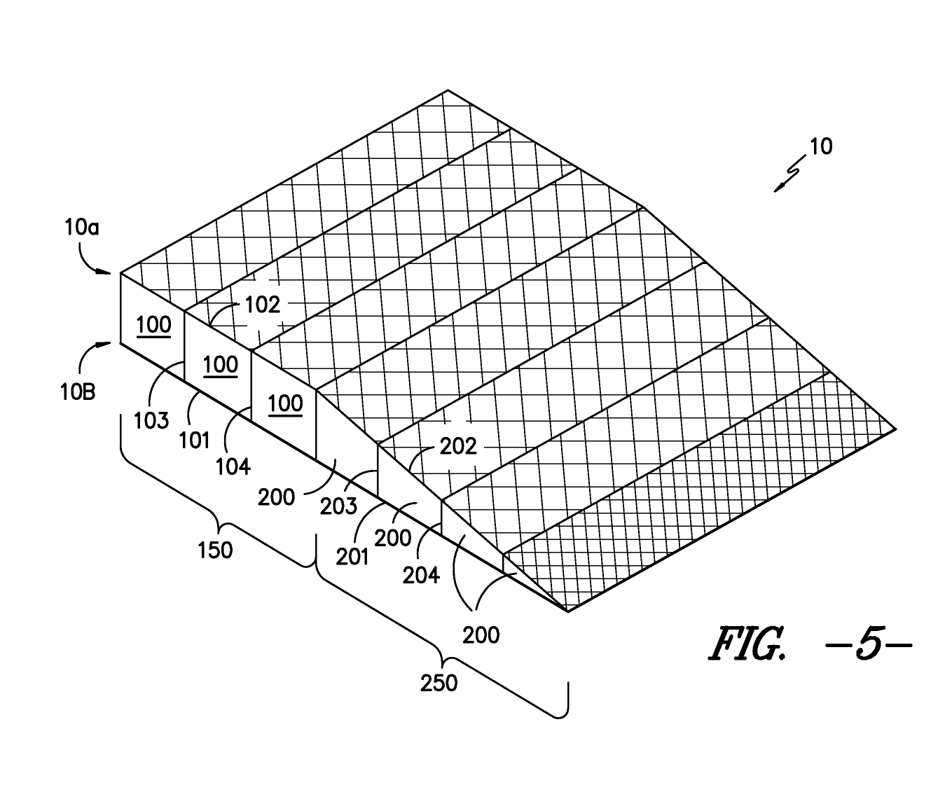

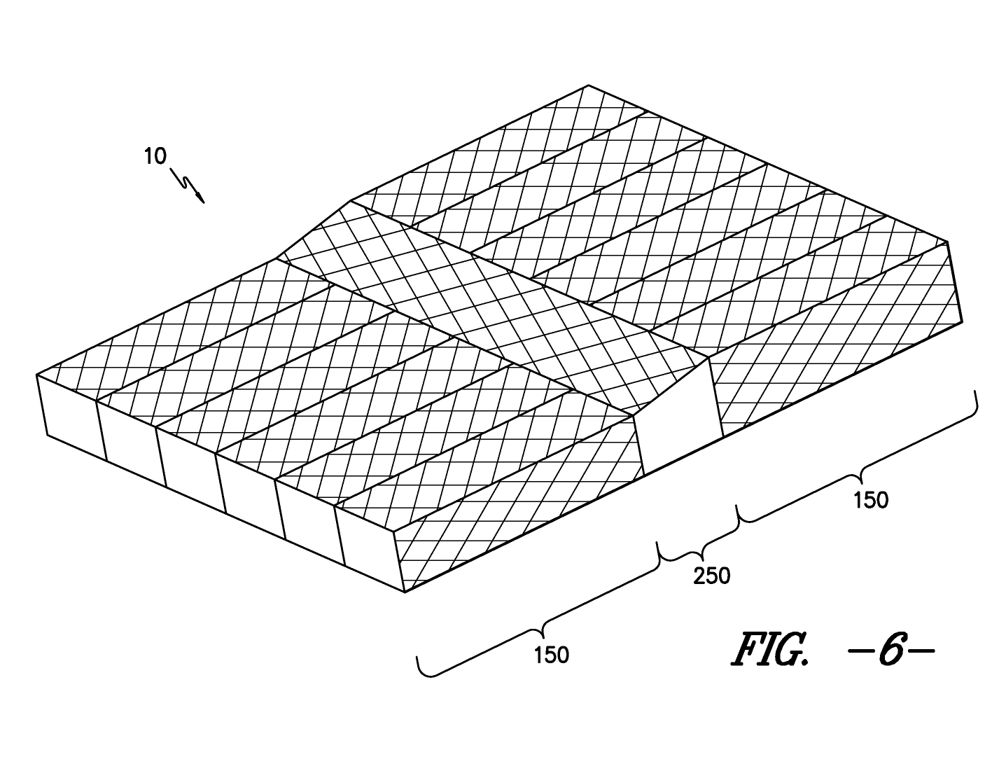

The tapered fiber reinforced core panel 10 contains at least one flat region 150 and at least one tapered region 250. In other embodiments the tapered fiber reinforced core panel 10 comprises two or more flat regions 150 and/or two or more tapered regions 250. FIGS. 5-10 illustrate alternative embodiments of the tapered reinforced core panel 10. FIG. 5 illustrates a tapered fiber reinforced core panel 10 having one flat region 150, one tapered region 250. FIG. 6 illustrates a tapered region 250 containing a single elongated strip 200 sandwiched between two flat regions 150. In FIG. 6, the thickness of the tapered region 250 at the edge of the tapered region 250 next to the first flat region 150 is approximately the same as the thickness of the first flat region. The thickness of the tapered region 250 at the edge of the tapered region 250 next to the second flat region 150 is approximately the same as the thickness of the second flat region, with the tapered region 250 providing a gradual change in thickness between the two flat regions 150. In order to provide a thickness transition in the length direction the elongated strip 200 of the tapered region 250, the elongated strips 200 longitudinal axis may be perpendicular to the elongated strips 100 of the flat region 150.

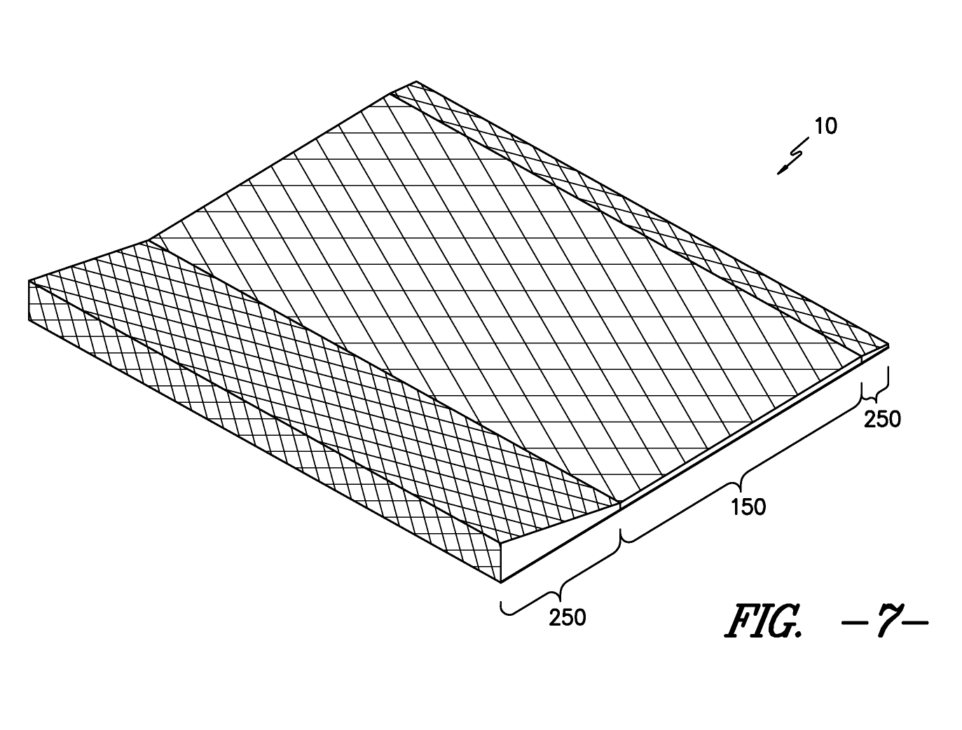

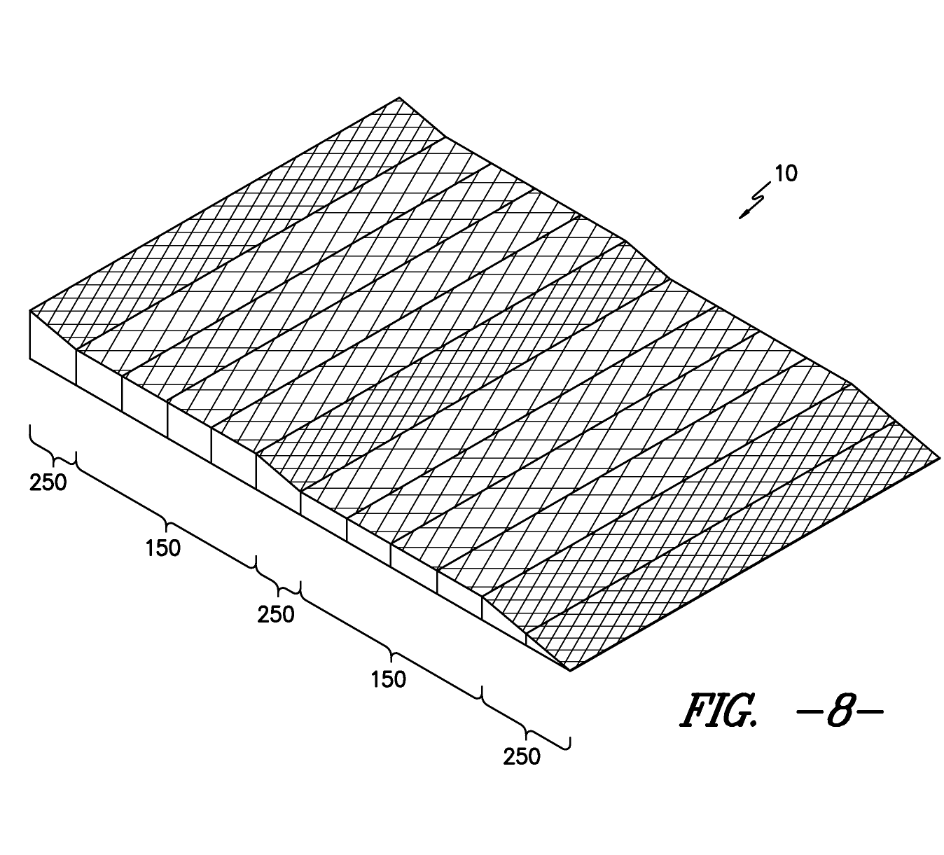

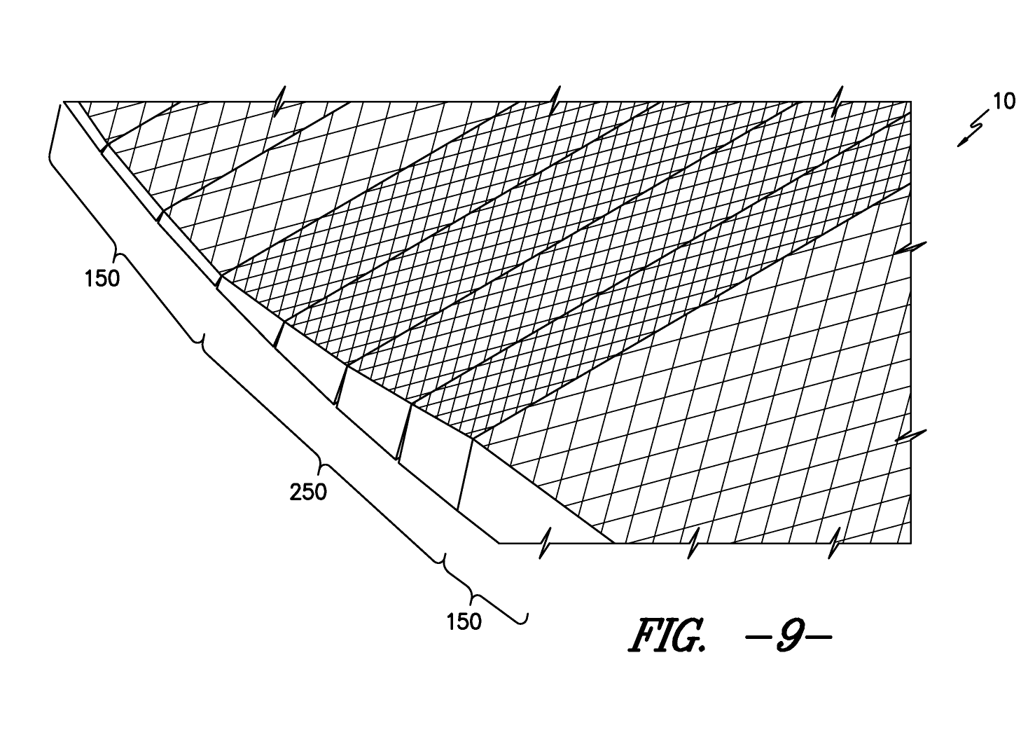

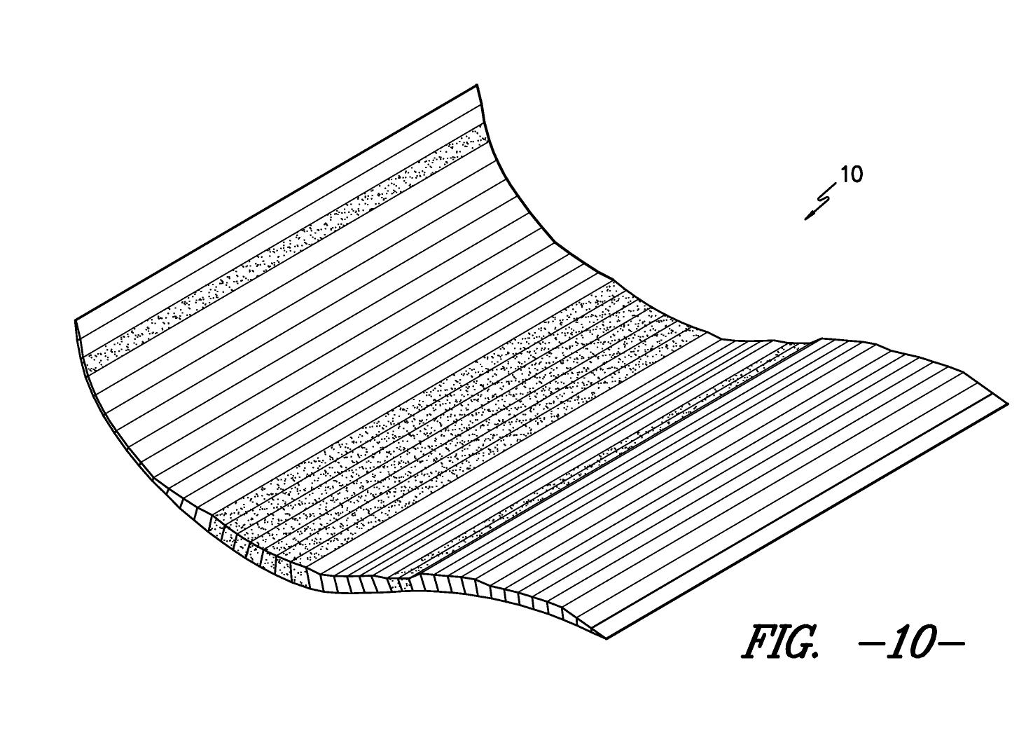

FIG. 7 illustrates a flat region 150 sandwiched between two tapered regions 250. The regions 150, 250 contain one or more elongated elements 100, 200 that are not shown in the Figure for ease of viewing. FIG. 8 illustrates a core panel 10 containing, in order, a tapered region 250, a flat region 150, a tapered region 250, a flat region 150, and a tapered region 250. FIG. 9 illustrates a tapered region 250 sandwiched between two flat regions 150. FIG. 10 illustrates a very complex core panel 10 (which may be used for a wind turbine blade or the like) containing many different flat and tapered regions.

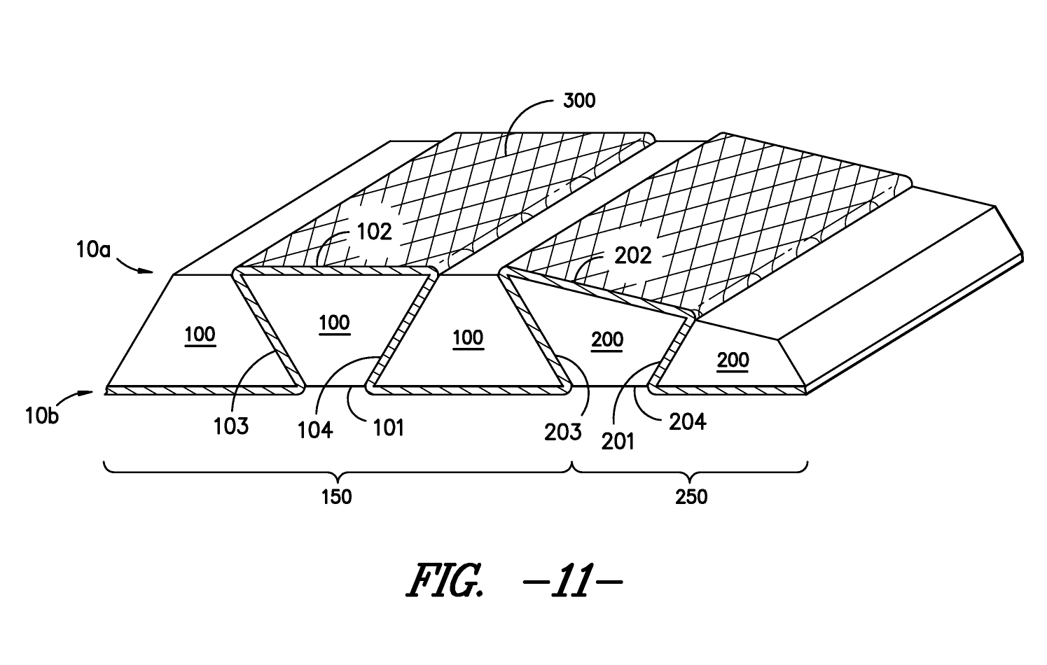

The elongated strips 100, 200 may have any suitable cross-sectional profile including, but are not limited to profiles having three or four faces. The faces (also referred to as side) may be straight or curved. In a preferred embodiment, the strips comprise 4 sides (designated as the first strip surface 102, 202, the second strip surface 101, 201, the first side surface 103, 203, and the second side surface 104, 204). The elongated strips 100, 200 may have cross-sectional profiles including squares, rectangles, quadrangles, trapezoids, and triangles. In the case of triangles, in this application it is assumed that one of the sides of the triangle would be adjacent the upper or lower core surface 10a, 10b, and the point formed by the other two sides meeting at an apex would have some amount of flatness to it such that it would be considered a “side” in this application. A tapered reinforced core panel 10 containing elongated strips 100 with a trapezoidal cross-section in the flat region 150 and elongated strips 100 with a quadrangle cross-section in the tapered region 250 is shown in FIG. 11.

The elongated strips 100, 200, may be formed from any suitable materials including but not limited to foam (closed-cell or open-cell), low density cellular material (for example balsa wood), fiber reinforced composite foam, and sealed plastic bottles. The foam may be, for example, polyurethane foam, expanded polystyrene foam, expanded polyethylene foam, expanded polypropylene foam, or a copolymer thereof. The strips may be formed of a rigid foam such as PVC, styrene acrylonitrile (SAN), or polymethacrylimide (PMI); a fire resistant foam such as phenolic; or hollow tubes made of plastic, metal, paper, or the like. In a potentially preferred embodiment, the elongated strips 100, 200 are composed of closed-cell foam. The type of closed-cell foam may be selected on the basis of processing parameters such as pressure, temperature, or chemical resistance or other desired panel properties, such as water or fire resistance, thermal insulation or light transmission.

The elongated strips 100, 200 preferably have resin absorption of less than about 250 g/m² on each exposed surface under vacuum pressure as measured by weight change and a deformation of less than 10% under a vacuum of 101 kPa as measured by thickness change. The elongated strips 100, 200 may also have a film or coating on at least one of the surfaces to reduce resin absorption or improve bonding between foam strips and reinforcement. The film or coating may be applied in any known manner and may include PVC, polyolefins, polyurethanes, and other polymers. Composite density (infused core panel 10) is one of the key performance parameters for composite sandwich panels. Resin pickup by foam or other core materials may be significant. Closed cell foams have moderate resin absorption at the surface. In one embodiment, there is an impervious to resin surface coating on at least one face of the elongated strips 100, 200.

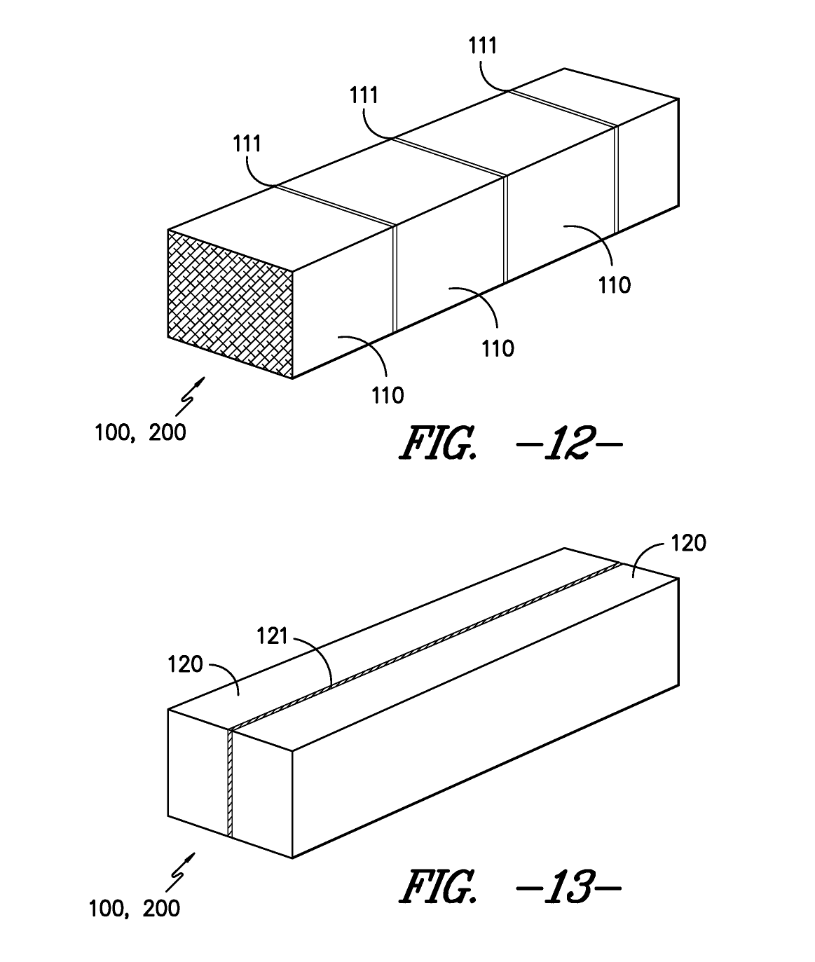

The elongated strips 100, 200 can be a unitary material, a collection of pieces, and/or reinforced material. Preferably, the elongated strips 100, 200 comprise reinforcements along their length. In the embodiment where the strips are collection of pieces, the pieces can be individual free pieces, or pieces held together such as with an adhesive. In one embodiment, at least a portion of the elongated strips 100, 200 contain low density material segments 110 and reinforcing planes 111 as shown in FIG. 12. The reinforcing planes 111 may be joined to the segments 110 by an adhesive. In one embodiment, the reinforcing planes 111 are a fibrous material with spaces to receive the polymeric matrix and create a stiff plane between the segments 110. If additional mechanical properties are desired in the plate of the structure but oriented perpendicular to the elongated strips, the stabilized reinforced core panel can be further cut into strips perpendicular to the initial foam strips and then wrapped with a second continuous reinforcement sheet.

In another embodiment shown in FIG. 13, the elongated strips 100, 200 comprise longitudinal segments 120 separated by longitudinal reinforcing plane 121. The longitudinal segments 120 can be bonded to the longitudinal reinforcing plane 121 by an adhesive. In one embodiment, the reinforcing plane 121 is a glass nonwoven with open spaces for receiving the polymeric matrix and creating a stiff longitudinal plane between segments 120.

Referring back to FIG. 1, there is shown that in the tapered fiber reinforcement core panel 10, there are a plurality of fibers 300 located adjacent the first side surfaces 103, 203 and the second side surfaces 104, 204 between the adjacent elongated strips 100, 200. The fibers may be located only between the adjacent elongated strips 100, 200, may be additionally covering at least a portion of the other surfaces 101, 102, 201, 202. These fibers 300 provide strength to the core panel 10 once it is infused with resin to become a composite.

In one embodiment, one layer of fibrous rovings is continuously and helically wound to surround each of the elongated strips 100, 200 along the length thereof. In another embodiment, a second layer of fibrous rovings is continuously and helically wound to surround the first layer of fibrous rovings on each elongated strip along the length thereof, where the rovings in the second layer of fibrous rovings extend helically in an opposite direction and cross the rovings in the first layer of fibrous rovings. The elongated strips 100 in the flat region 150 and the elongated strips 200 in the tapered region 250 would be wrapped in the same manner. More information about the helically wound rovings and the method of applying the helically winding the elongated strips may be found in U.S. Pat. No. 7,393,577 (Day et al.) which is hereby incorporated by reference in its entirety.

In another embodiment shown in FIG. 11, the fibers 300 are in a continuous fibrous reinforcement sheet that is threaded through the elongated strips 100, 200 such that the fibrous reinforcement sheet is disposed between the elongated strips 100, 200 (adjacent the first side surfaces 103, 203 and the second side surfaces 104, 204) and on at least one of the first strip surface 102, 202 and the second strip surface 101, 201. In one embodiment, the reinforcement sheet forms at least about fifty (50%), more preferably sixty five percent (65%) of the surface area of the upper and lower core surfaces 10a, 10b.

The continuous fibrous reinforcing sheet can be a woven, knit, bonded textile, nonwoven (such as a chopped strand mat), or sheet of strands. The fibrous reinforcing sheet can be unidirectional strands such as rovings and may be held together by bonding, knitting a securing yarn across the rovings, or weaving a securing yarn across the rovings. In the case of woven, knit, warp knit/weft insertion, nonwoven, or bonded the textile can have yarns or tape elements that are disposed in a multi- (bi- or tri-) axial direction. Preferably, the continuous fibrous reinforcement sheet is a multi-axial knit. A multi-axial knit has high modulus, non-crimp fibers that can be oriented to suit a combination of shear and compression requirements. More details regarding the fibers being a continuous fibrous reinforcing sheet and the method of using them with a core panel may be found in U.S. Pat. No. 7,851,048 (Brandon et al.) which is incorporated herein by reference in its entirety.

The fibers 300 may be made of any suitable material in any form. The fibers may be, for example, fiberglass, carbon, polyester, aramid, nylon, natural fibers, and mixtures thereof. The fibers may be monofilament, multifilament, staple, tape elements, in yarns, or a mixture thereof. Glass rovings are preferred due to their low cost, relatively high modulus, and good compatibility with a variety of resins. The fibers 300 used preferably have a high strength to weight ratio. Preferably, the fibers have strength to weight ratio of at least 1 GPa/g/cm³ as measured by standard fiber properties at 23° C. and a modulus of at least 70 GPa.

Additional layers may be added to the tapered fiber reinforced core panel 10 on the upper core surface 10a and/or the lower core surface 10b for added strength, ease of handling, and other desired properties.

In one embodiment, a veil may be applied to the upper core surface 10a and/or the lower core surface 10b to improve the handling characteristics of the core prior to molding. The veil may also be referred to as a scrim or face stabilizer. Typically, the veil(s) are of very open fabric, such as a scrim. The veil may also be fibrous layers, unidirectional fibers, a nonwoven fiberglass, a thermoplastic film, an adhesive layer, adhesive fibers, or mixtures thereof. If desired for greater bending flexibility, a veil may be applied to only one surface of the core panel 10. Other means of unitizing the core panel 10 (before infusion) include adhering parallel bands of hot melt yarn or scrim across the wound strips or applying pressure sensitive adhesive to the faces of the strips which are in contact with each other.

In one embodiment, skins may be added to at least one of the upper core surface 10a and lower core surface 10b. Preferably, skins are added to both the upper core surface 10a and the lower core surface 10b. The skins may be made up of one or more than one layers of fibers. Preferably, the skins are made up of at least two layers of fibers. Any suitable fiber may be used in the skins including but not limited to organic or inorganic structural reinforcing fabrics such as fiberglass, carbon fibers, aramid fibers such as is available under the name KEVLAR®, linear polyethylene or polypropylene fibers such as is available under the name SPECTRA®, thermoplastic tape fibers, polyester fibers, nylon fibers, or natural fibers. The materials and constructions may also vary between the layers in the skins. The skins may contain layers of woven, knit, bonded textile, nonwoven fibers, or sheet of strands such as rovings.

In one embodiment, two or more reinforced core panels 10 may be stacked (tapered or not). The reinforced core panels 10 can be arranged with the strips 100, 200 in each core panel 10 parallel to one another or turned at 90 degrees to one another. An additional layer of reinforcement like as used in the skins may be added between the reinforced core panels 10.

To form a composite core panel, the tapered fiber reinforced core panel 10 is impregnated or infused with a polymeric matrix of resin which flows, preferably under differential pressure, through at least a portion of core panel 10 (including the fibers 300 and any optional skins and veils). Preferably, the resin flows throughout all of the reinforcing materials of the core panel 10 (the fibers 300 and any optional skins and veils) and cures to form a rigid, load bearing structure. Resin such as a polyester, a vinylester, an epoxy resin, a bismaleimide resin, a phenol resin, a melamine resin, a silicone resin, or thermoplastic monomers of PBT or Nylon etc. may be used. The fibers can also be combined with resin before wrapping around the foam strips. Resins include b-staged thermosets as in thermoset prepregs or thermoplastic resins as in tape yarns, commingled yarns, or unidirectional sheets.

Flowing the resin throughout the core panel 10 under differential pressure may be accomplished by processes such as vacuum bag molding, resin transfer molding or vacuum assisted resin transfer molding (VARTM). In VARTM molding, the core and skins are sealed in an airtight mold commonly having one flexible mold face, and air is evacuated from the mold, which applies atmospheric pressure through the flexible face to conform the composite structure 10 to the mold. Catalyzed resin is drawn by the vacuum into the mold, generally through a resin distribution medium or network of channels provided on the surface of the panel, and is allowed to cure. The composite structure 10 may have flow enhancing means such as, but not limited to: grooves or channels cut into the major and minor surfaces of the strips; a network of grooves on all sides of the strips; additional elements in the reinforcement fabric such as voids or flow enhancing yarns. Additional fibers or layers such as surface flow media can also be added to the composite structure to help facilitate the infusion of resin. A series of thick yarns such as heavy rovings or monofilaments can be spaced equally apart in one or more axis of the reinforcement to tune the resin infusion rate of the composite panel.

A preferred method to form the elongated strips 100, 200 begins with a sheet of suitable material which is then cut into separate elongated strips 100, 200. The elongated strips 100 comprising the flat region 150 are cut by passing the sheet through a plurality of circular saw blades spaced apart on a single arbor to allow multiple elongated strips to be cut in a single pass. There are two preferred methods to cut the elongated strips 200 comprising the tapered region 250 of the core panel. The first method begins with the process used to cut the elongated strips 100 comprising the flat region and in a second operation, using a single saw blade fixed at the desired taper angle, cut the face of the elongated strips 100 to the desired angle creating elongated strips 200. In a more preferred method a special apparatus is used to cut two tapered strips 200 out of the sheet of low density material per pass. This special apparatus has a fence on which the edge of the sheet is aligned, along with two saw blades, one at the desired angle and one vertical such that each pass two strips are cut from the sheet, and the final cut from the sheet is perpendicular to the face of the sheet, and the sheet is ready for the next pass.

It is preferred that the elongated strips 100, 200 are helically wound with reinforcing roving. Strips are placed end to end and passed through a winding apparatus that applies roving in a continuous helical wrap around the perimeter of the elongated strips 100, 200. The apparatus consists of at least one winding head containing at least one reinforcing roving, which rotates as the elongated strips are passed through the center. The velocity of the strips relative to the RPM of the winding head can be adjusted to add more or less reinforcement as a specific application warrants. The wound elongated strips are then cut to length to form the elongated strips 100, 200.

In some cases it is desirable to use a single tapered elongated strip as part of a core panel containing many flat elongated strips. In other cases multiple elongated strips will be assembled together in order to make a transition between two thicknesses that differ more than a single elongated strip.

Multiple strips may be bonded together in one embodiment. This can be done manually by placing elongated strips 200 side by side, applying pressure perpendicular to the longitudinal direction of the strips and while under pressure bonding the tapered elongated strips together to form a core panel. In another embodiment the core panel is bonded while not under pressure. The process of bonding can use a surface reinforcement veil or scrim already containing an adhesive, or a separate adhesive and surface reinforcement. It is also possible to bond the elongated strips together by applying adhesive in between the adjacent elongated strips. A special apparatus could also be used to bond the strips together into a finished core panel. This apparatus could perform the steps of aligning, applying pressure, and bonding the elongated strips in a continuous or batch process to increase the speed and or consistency of the assembly of the elongated strips into a core panel.

In one embodiment a core panel comprising flat elongated strips 100 will be made separately from a core panel comprising the tapered elongated strips 200. These core panels will then be bonded together to form a core panel with a thickness transition. In many cases the core panel comprised of the flat elongated strips will need to be cut to the proper shape to fit the mold it will be placed into. Typically the cut is through the thickness of the core panel, perpendicular to the surface of the panel 10a and at an acute angle to the longitudinal direction of the elongated strips. When the core panel comprising the flat region is cut, the core panel comprising the tapered region must also be cut so that the ends of the flat region 150 match the ends of the tapered region 250. The cuts to the tapered region are typically made through the thickness of the panel perpendicular to the surface and at an acute angle to the transverse direction of the elongated strips 200. This angle will match the angle cut on the core panel comprising the flat region 250. It is then necessary to attach the core panel comprising the tapered region 250 to the core panel comprising the flat region 150. In order to simplify the attachment a preferred embodiment is to extend the reinforcing scrim used to bond the tapered elongated strips 200 together beyond the tapered region 250 of the core panel adjacent to the edge with a thickness matching the flat core panel. This extended reinforcing scrim will allow the tapered region 250 of the core panel to easily attach to the flat region of the core panel. This is only a preferred method and other methods could also be used including but not limited to; using a separate reinforcement, contact adhesive, or hot melt adhesive applied in between the flat region 150 and the tapered region 250.

Once the final core panel is constructed with both the flat section 150 and the tapered section 250, the panel 10 is typically placed into a mold forming the shape of the composite 400. The core panel 10 described above is typically one of many core panels that will ultimately make up the finished part. A typical example of how the final part is constructed follows.

Multiple layers of reinforcing fabric, typically fiberglass multi-axial, is first placed in the mold followed by the core panels. Some of the core panels may contain one or more tapered elongated strips 200 to smoothly transition between flat regions 150 of different thicknesses. After the core panels are placed in the mold additional reinforcement layers are placed in the mold on top of the core. The top layer of reinforcement is then covered with a release fabric or membrane which allows resin to flow through, but is also easily removed from the part. The release fabric is then covered with strategically placed flow mesh, which provides space for the resin to flow, and ensures a complete infusion before the resin begins to cure. The flow mesh is strategically placed so that the resin can reach each part of the mold. On top of the flow mesh resin distribution lines are placed to deliver resin quickly to different areas of the part. Additionally individual lines can be started and stopped as the part is filled to allow some control over the resin flow. On top of the lines a vacuum bag is placed and sealed to the perimeter of the mold closing off the mold from the outside. In many cases the mold contains vacuum ports to allow the air to be evacuated from the part. Once the part is sealed, and all of the air has been removed, the resin lines are opened and resin is allowed to fill the. Typically the resin is polyester or epoxy which has be catalyzed or mixed prior to entering the part and thus has already started curing. After the part is filled, the flow of resin is stopped and the part is allowed to fully cure under vacuum.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A tapered fiber reinforced core panel adapted for use with a hardenable resin having a width, a length, an upper core surface, a lower core surface, and a thickness defined as the distance between the upper core surface and the lower core surface, wherein the core panel thickness varies across at least one of the width or length of the core panel, wherein the core panel comprises:
a plurality of elongated strips of low density cellular material, wherein each elongated strip has a length, a longitudinal axis, a first strip surface facing the upper core surface of core panel, a second strip surface facing the lower core surface of core panel, a first side surface connecting the first surface and the second surface, and a second side surface connecting the first surface and the second surface, wherein the first side surface is parallel to the second side surface, wherein the first strip surface and second strip surface of at least a portion of the elongated strips are not parallel, and wherein the side surfaces of the elongated strips face the side surfaces of adjacent elongated strips; and,
a plurality of fibers located adjacent the first and second side surfaces between adjacent elongated strips.

2. The tapered fiber reinforced core panel of claim 1, wherein the a plurality of fibers located adjacent the side surfaces between adjacent elongated strips comprise at least one layer of fibrous rovings continuously and helically surrounding each of the elongated strips along the length thereof.

3. The tapered fiber reinforced core panel of claim 2, further comprising including a second layer of fibrous rovings continuously and helically surrounding the first layer of fibrous rovings on each elongated strip along the length thereof, wherein the rovings in the second layer of fibrous rovings extend helically in an opposite direction and cross the rovings in the first layer of fibrous rovings.

4. The tapered fiber reinforced core panel of claim 1, wherein the plurality of fibers located adjacent the side surfaces between adjacent elongated strips comprise a continuous reinforcement sheet.

5. The tapered fiber reinforced core panel of claim 1, wherein in the elongated strips having the first surface and second surface not parallel, the first side surface is perpendicular to the second strip surface and the second side surface is perpendicular to the second strip surface.

6. A tapered fiber reinforced core panel adapted for use with a hardenable resin having width, a length, an upper core surface, a lower core surface, a flat region, a tapered region, and a thickness defined as the distance between the upper core surface and the lower core surface, wherein the core panel thickness varies in the tapered region of the core panel, wherein the core panel comprises:
a plurality of elongated strips of low density cellular material, wherein each elongated strip has a length, a longitudinal axis, a first strip surface facing the upper core surface of core panel, a second strip surface facing the lower core surface of core panel, a first side surface connecting the first surface and the second surface, and a second side surface connecting the first surface and the second surface, wherein the side surfaces of the elongated strips face the side surfaces of adjacent elongated strips; and,
a plurality of fibers located adjacent the side surfaces between adjacent elongated strips.
wherein in the flat region of the core panel, the thickness of the core panel is approximately constant in the width and length of the flat region and the first strip surface and second strip surface of the elongated strips within the flat region are parallel;
wherein in the tapered region of the core panel, the thickness of the core panel changes in at least one of the width and length of the tapered region and the first strip surface and second strip surface of the elongated strips are not parallel.

7. The tapered fiber reinforced core panel of claim 6, wherein the longitudinal axes of the elongated strips within the flat region are aligned and the longitudinal axes of the elongated strips within the tapered region are aligned.

8. The tapered fiber reinforced core panel of claim 6, wherein the a plurality of fibers located adjacent the side surfaces between adjacent elongated strips comprise at least one layer of fibrous rovings continuously and helically surrounding each of the elongated strips along the length thereof.

9. The tapered fiber reinforced core panel of claim 8, further comprising including a second layer of fibrous rovings continuously and helically surrounding the first layer of fibrous rovings on each elongated strip along the length thereof, wherein the rovings in the second layer of fibrous rovings extend helically in an opposite direction and cross the rovings in the first layer of fibrous rovings.

10. The tapered fiber reinforced core panel of claim 6, wherein in flat and tapered regions of the core panel, the first side surface of the elongated strips is parallel to the second side surface the elongated strips and the second side surface is perpendicular to the second strip surface of the elongated strips.

11. The tapered fiber reinforced core panel of claim 6, wherein the plurality of fibers located adjacent the side surfaces between adjacent elongated strips comprise a continuous reinforcement sheet.

12. The tapered fiber reinforced core panel of claim 6, wherein the elongated strips comprise reinforcements along their length.

13. A tapered fiber reinforced composite having a width, a length, an upper core surface, a lower core surface, and a thickness defined as the distance between the upper core surface and the lower core surface, wherein the core panel thickness varies across at least one of the width or length of the core panel, wherein the core panel comprises:
a plurality of elongated strips of low density cellular material, wherein each elongated strip has a length, a longitudinal axis, a first strip surface facing the upper core surface of core panel, a second strip surface facing the lower core surface of core panel, a first side surface connecting the first surface and the second surface, and a second side surface connecting the first surface and the second surface, wherein the first side surface is parallel to the second side surface, wherein the first strip surface and second strip surface of at least a portion of the elongated strips are not parallel, and wherein the side surfaces of the elongated strips face the side surfaces of adjacent elongated strips;
a plurality of fibers located adjacent the side surfaces between adjacent elongated strips; and,
a cured resin extending at least partially through the fibrous rovings.

14. The tapered fiber reinforced composite of claim 13, wherein the a plurality of fibers located adjacent the side surfaces between adjacent elongated strips comprise at least one layer of fibrous rovings continuously and helically surrounding each of the elongated strips along the length thereof.

15. The tapered fiber reinforced composite of claim 14, further comprising including a second layer of fibrous rovings continuously and helically surrounding the first layer of fibrous rovings on each elongated strip along the length thereof, wherein the rovings in the second layer of fibrous rovings extend helically in an opposite direction and cross the rovings in the first layer of fibrous rovings.

16. The tapered fiber reinforced core panel of claim 13, wherein the plurality of fibers located adjacent the side surfaces between adjacent elongated strips comprise a continuous reinforcement sheet.

17. A tapered fiber reinforced composite having width, a length, an upper core surface, a lower core surface, a flat region, a tapered region, and a thickness defined as the distance between the upper core surface and the lower core surface, wherein the core panel thickness varies in the tapered region of the core panel, wherein the core panel comprises:
a plurality of elongated strips of low density cellular material, wherein each elongated strip has a length, a longitudinal axis, a first strip surface facing the upper core surface of core panel, a second strip surface facing the lower core surface of core panel, a first side surface connecting the first surface and the second surface, and a second side surface connecting the first surface and the second surface, wherein the side surfaces of the elongated strips face the side surfaces of adjacent elongated strips; and,
a plurality of fibers located adjacent the side surfaces between adjacent elongated strips;
a cured resin extending at least partially through the fibrous rovings;
wherein in the flat region of the core panel, the thickness of the core panel is approximately constant in the width and length of the flat region and the first strip surface and second strip surface of the elongated strips within the flat region are parallel;
wherein in the tapered region of the core panel, the thickness of the core panel changes in at least one of the width and length of the tapered region and the first strip surface and second strip surface of the elongated strips are not parallel.

18. The tapered fiber reinforced core panel of claim 17, wherein the longitudinal axes of the elongated strips within the flat region are aligned and the longitudinal axes of the elongated strips within the tapered region are aligned.

19. The tapered fiber reinforced composite of claim 18, wherein the a plurality of fibers located adjacent the side surfaces between adjacent elongated strips comprise at least one layer of fibrous rovings continuously and helically surrounding each of the elongated strips along the length thereof.

20. The tapered fiber reinforced composite of claim 17, further comprising including a second layer of fibrous rovings continuously and helically surrounding the first layer of fibrous rovings on each elongated strip along the length thereof, wherein the rovings in the second layer of fibrous rovings extend helically in an opposite direction and cross the rovings in the first layer of fibrous rovings.

21. The tapered fiber reinforced composite of claim 17, wherein the plurality of fibers located adjacent the side surfaces between adjacent elongated strips comprise a continuous reinforcement sheet.
